(19) United States
(12) Patent Application Publication
(10) Pub. No.: US 2014/0344263 A1
(43) Pub. Date: Nov. 20, 2014

(54) Identification of acronym expansions

(71) Applicants: Kedar Dhamdhere, Sunnyvale, CA (US); P. Pandurang Nayak, Palo Alto, CA (US); Thomas Strohmann, Fremont, CA (US); Brian F. Cooper, San Jose, CA (US)

(72) Inventors: Kedar Dhamdhere, Sunnyvale, CA (US); P. Pandurang Nayak, Palo Alto, CA (US); Thomas Strohmann, Fremont, CA (US); Brian F. Cooper, San Jose, CA (US)

(21) Appl. No.: 13/136,505

(22) Filed: Aug. 1, 2011

(51) Int. Cl. G06F 17/30

(52) U.S. Cl. 707/727; 707/E17.084

(57) ABSTRACT

Methods, systems, and apparatus, including computer programs encoded on a computer storage medium, for receiving a search query that includes a query term from a client device; obtaining first search results for the search query; identifying a candidate expansion of the query term in text associated with the first search results; revising the search query to include the candidate expansion of the query term; and obtaining second search results for the revised search query.

### BACKGROUND

This specification relates to search engines, and one particular implementation relates to evaluating acronyms for use in revising search queries.

Search engines identify resources that are responsive to search queries. In doing so, a search engines may, for example, match query terms with terms that occur in the resources, or with terms that occur in metadata associated with the resources.

### SUMMARY

In general, one aspect of the subject matter described in this specification may be embodied in methods that execute a search query using a query term, when the query term is identified as likely being an acronym (referred to by this specification as a “likely acronym”). The methods evaluate whether the search results for the search query include phrases that could represent expansions of the likely acronym. If expansions of the likely acronym are found in the search results, the search query is revised to include the expansion instead of or in addition to the likely acronym, and the revised search query is executed. Search results that are identified in response to the original search query and/or the revised search query are presented for display on a search results page.

In general, another aspect of the subject matter described in this specification may be embodied in methods that include the actions of receiving a search query that includes a query term from a client device; obtaining first search results for the search query; identifying a candidate expansion of the query term in the first search results; revising the search query to include the candidate expansion of the query term; and obtaining second search results for the revised search query.

Other embodiments of this aspect include corresponding systems, apparatus, and computer programs, configured to perform the actions of the methods, encoded on computer storage devices.

These and other embodiments can each optionally include one or more of the following features. Identifying a candidate expansion includes determining that an aggregated quality score associated with the first search results satisfies a threshold. Identifying a candidate expansion includes receiving a user selection indicating that the query term is a candidate acronym. Identifying a candidate expansion of the query term in the first search results includes identifying the candidate expansion in one or more snippets of the first search results. Identifying a candidate expansion of the query term in the first search results includes identifying the candidate expansion in one or more titles of the first search results. Identifying a candidate expansion of the query term in the first search results includes determining a frequency with which a possible expansion occurs in the first search results, determining that the frequency with which the possible expansion occurs in the first search results satisfies a threshold, and in response to determining that the frequency with which the possible expansion occurs in the first search results exceeds the threshold, identifying the possible expansion as the candidate expansion of the query term.

Determining a frequency with which the candidate expansion occurs in the first search results includes determining a frequency with which the candidate expansion occurs in a document referenced in the first search results. Determining a frequency with which the query terms occurs in the first search results includes determining a frequency with which the candidate expansion occurs in a subset of documents returned with the first search results. Determining a frequency with which the query term occurs in the first search results includes determining a frequency with which the candidate expansion occurs in all documents returned with the first search results.

Identifying a candidate expansion of the query term in the first search results includes determining a number of documents returned with the first search results in which a candidate expansion is included, determining that the number of documents in which the candidate expansion is included satisfies a threshold, and in response to determining that the number of documents in which the candidate expansion is included exceeds a specified threshold, identifying the candidate expansion as the candidate expansion of the query term.

Revising the search query includes adding the candidate expansion to the search query. Revising the search query includes substituting the candidate expansion for the query term in the search query. The second search results include results from the first search results and additional results. Documents returned with the first and second search results are included in the obtained second search results. The method can further include providing the obtained second search results for display to a user. The method can further include determining that the query term satisfies one or more exclusionary rules and in response to the determination, identifying a candidate expansion of the query term in the first search results. The first search results can not be provided for display to a user.

Particular embodiments of the subject matter described in this specification can be implemented so as to realize one or more of the following advantages. Search queries containing acronyms can be revised to obtain more relevant search results. Acronyms can be identified for one or more query terms contained in an original query. Expansions for the identified acronyms can be identified using search results that are provided in response to the original query. The original query can be revised using the identified expansions. Search results responsive to the revised query can be obtained to provide more relevant search results.

The details of one or more embodiments are set forth in the accompanying drawings and the description below. Other features and advantages will be apparent from the description and drawings, and from the claims.

### DESCRIPTION OF DRAWINGS

FIGS. 1 and 2 are diagrams of an example search systems in which acronym expansions are used to revise search queries.

FIG. 3 is a flowchart of an example process for obtaining search results.

FIGS. 4A-C are example user interfaces.

Like reference symbols in the various drawings indicate like elements.

### DETAILED DESCRIPTION

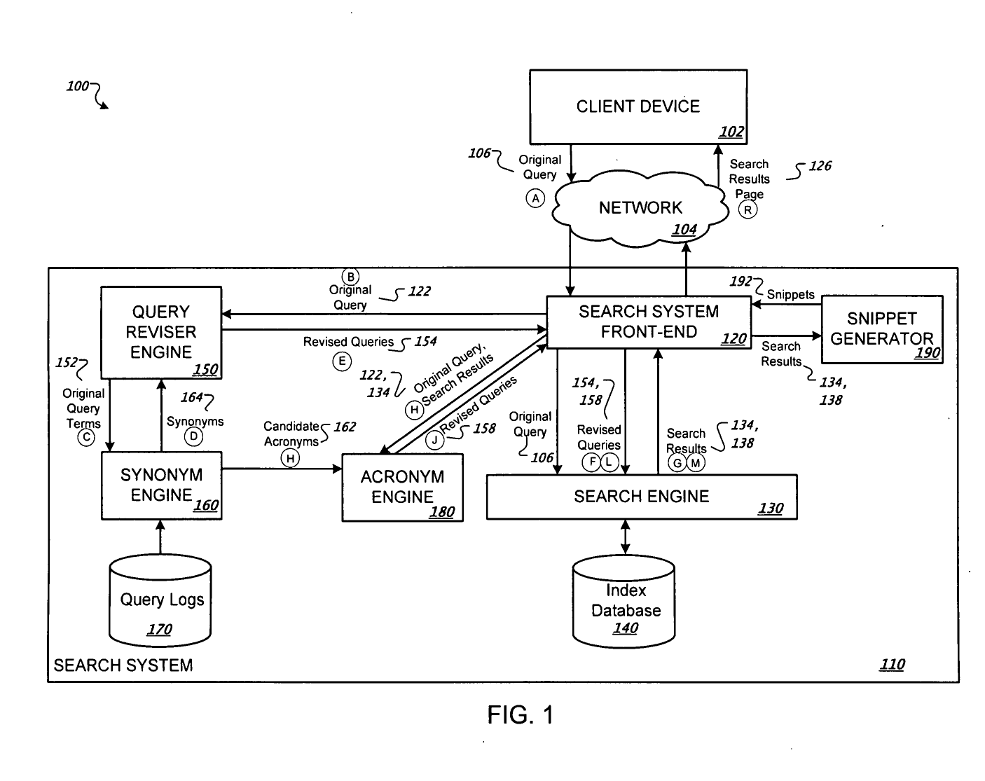

FIG. 1 is a diagram of an example search system 100 in which acronym expansions are used to revise search queries. In general, the system 100 includes a client device 102 in communication with a search system 110 over a network 104. The search system 110 receives a query 106, referred to by this specification as the “original query,” from the client device 102 over network 104. The search system 110 provides a search results page 126 that presents search results 134 that are identified as being responsive to the original query 106 and/or one or more revised queries 154, 158.

The search system 110 can be implemented as, for example, computer programs running on one or more computers in one or more locations that are in communication with each other through a network. The search system 110 includes a search system front end 120 (or a “gateway server”) to coordinate requests between components of the search system 100, and between the search system 110 and the client device 102.

In general, the search system front-end 120 receives search queries from client devices, and routes the queries to the appropriate engines so that search results pages may be obtained. In some implementations, routing occurs by referencing static routing tables, or routing may occur based on the current network load of an engine, so as to accomplish a load balancing function. The search system front-end 120 also provides the resulting search engine results pages to client devices. In doing so, the search system front-end 120 acts as a gateway, or interface, between client devices and the search engine 130. In some implementations, the search system 110 contains many thousands of computing devices to account for the scale of queries received by the search system 110.

The search system 110 also includes a search engine 130, a query reviser engine 150, a synonym engine 160, and an acronym engine 180. In general, the query reviser engine 150 generates revised queries, for example by revising original queries to include synonyms that the synonym engine 160 identifies for the terms of the original queries. The acronym engine 180 evaluates query terms that are identified as acronyms or as likely acronyms, and identifies candidate expansions of the query terms. The candidate expansions may be identified through interaction with the search system front-end 120, and the query terms and candidate expansions may be communicated to and from the synonym engine 160.

As used by this specification, an “engine” (or “software engine”) refers to a software implemented input/output system that provides an output that is different than the input. An engine may be an encoded block of functionality, such as a library, a platform, Software Development Kit (“SDK”), or an object. The network 104 may include, for example, a wireless cellular network, a wireless local area network (MAN) or Wi-Fi network, a Third Generation (3G) or Fourth Generation (4G) mobile telecommunications network, a wired Ethernet network, a private network such as an intranet, a public network such as the Internet, or any appropriate combination thereof.

The search system front-end 120, search engine 130, query reviser engine 150, synonym engine 160, and acronym engine 180 can be implemented on any appropriate type of computing device (e.g., servers, mobile phones, tablet computers, music players, e-book readers, laptop or desktop computers, PDAs, smart phones, or other stationary or portable devices) that includes one or more processors and computer readable media. Among other components, the client device 102 includes one or more processors, computer readable media that store software applications (e.g. a browser or layout engine), an input module (e.g., a keyboard or mouse), communication interface, and a display. The computing device or devices that implement the search system front-end 120, the search engine 130, the query reviser engine 150, the synonym engine 160, and the acronym engine 180 may include similar or different components.

Two or more of the search system front-end 120, the search engine 130, the query reviser engine 150, the synonym engine 160, and the acronym engine 180 may be implemented on the same computing device, or on different computing devices. Because the search engine results page 126 is generated based on the collective activity of the search system front-end 120, search engine 130, the query reviser engine 150, the synonym engine 160, and the acronym engine 180, the user of the client device 102 may refer to these engines collectively as a “search engine.” This specification, however, refers to the search engine 130, and not the collection of engines, as the “search engine,” since the search engine 130 identifies the search results 134 and 138 in response to the user-submitted search query 106 and one or more revised queries 158, respectively.

In FIG. 1, a user of the client device 102 submits an original query 106 to the search system 110 over the network 104 during state (A). The user may submit the original query 106 by initiating a search dialogue on the client device 102, speaking or typing the query terms 152 of the original query 106, and then pressing a search initiation button or control on the client device 102. The client device 102 formulates the original query 106, e.g., by adding search parameters to the query terms 152, and transmits the original query 106 over the network 104.

Although this specification refers to the original query 106 as an “original” query, such reference is merely intended to distinguish this query from other queries, such as the revised queries that are described below. The designation of the original query 106 as “original” is not intended to require the original query 106 to be the first query that is entered by the user, or even to require that the query be manually entered. For example, the original query 106 may be the second or subsequent query entered by the user, or the original query 106 may be automatically derived (e.g., by the query reviser engine 150) or may be modified based upon prior queries entered by the user, location information, and the like.

The search system front-end 120 receives the original query 106 and communicates the original query 106 to the query reviser engine 150 during state (B). The query reviser engine 150 can generate one or more revised queries 154 based on the original query 106. In some implementations, the query reviser engine 150 generates a revised query by adding terms to the original query 106 using synonyms 164 for the query terms 152 of the original query 106. In some other implementations, the query reviser engine 150 generates a revised query by substituting synonyms 164 of the query terms 152 for the actual query terms 152 of the original query. Other query revision approaches may also be used, such as query revision approaches that revise the original query 106 to promote results that include one or more of the synonyms 164.

The query reviser engine 150 can obtain synonyms 164 for the query terms 152 of the original query 106 from the synonym engine 160. Specifically, the query reviser engine 150 communicates the query terms 152 of the original query 106 to the synonym engine 160 during state (C).

In some implementations, synonyms can be obtained using a static lookup process. In these implementations, the synonym engine 160 evaluates synonym rules to identify synonyms 164 for the query terms 152 of the original query 106. The synonym engine 160 can identify synonyms used to generate revised queries by evaluating previously received queries stored in query logs 170. The synonym engine 160 can read and analyze the query logs 170 in order to identify terms that are likely to be considered synonyms, and can define synonym rules accordingly.

In some implementations, the synonym engine 160 can define a synonym rule for a pair of terms that are determined to be synonyms, and can use the synonym rule at a later time to identify synonyms for query terms. For example, for an original query that includes the terms “cat food,” the synonym engine 160 can define a synonym rule that indicates that “pet” is a synonym for “cat,” and can generate a revised query using “pet” as term that should be added to original query, or substituted for a term in the original query.

Synonym rules can be defined to apply generally, or can be defined to apply only when particular conditions, or “query contexts,” are satisfied. The query context of a synonym rule can specify, for example, one or more other terms that must be present in the query for the synonym rule to apply. Furthermore, query contexts can specify relative positions of the other terms in among the query terms (e.g. to the right or left of a query term under evaluation) or can specify a general location (e.g. anywhere in the query).

For example, a particular synonym rule can specify that the term “pet” is a synonym for the query term “dog,” but only when “dog” is followed by the term “food” in the query. Multiple distinct synonym rules can generate the same synonym for a given query term. For example, for the query term “dog” in the query “dog food,” the term “pet” can be specified as a synonym for “dog” by both a synonym rule for “dog” in the general context and a synonym rule for “dog” when followed by “food.”

In some other implementations, synonyms can be obtained using a dynamic process. In such implementations, the query terms 152 are evaluated based on criteria, as described in more detail below, and, if such criteria is satisfied, the synonyms are obtained dynamically using text associated with the search results 134.

The synonym engine 160 communicates the synonyms 164 of the query terms 152 to the query reviser engine 150 during state (D). The query reviser engine 150 generates one or more revised queries 154 by, for example, adding the synonyms 164 to the query terms 152 of the original query 106, or substituting the synonyms 164 for certain of the query terms 152 of the original query 106.

The query reviser engine 150 transmits the one or more revised queries 154 to the search system front-end 120 during state (E). The search system front-end 120 communicates the original query 106 and/or the one or more revised queries 154 to the search engine 130 during state (F). The search engine 130 obtains search results 134 that it identifies as being responsive to the original query 122 and/or the revised queries 154.

The search engine 130 can identify search results 134 for the original query 122 and/or the revised queries 154 using an index database 140 that stores an index of resources (e.g., web pages, images, documents, or articles on the network 104). The search engine 130 can combine and rank the identified search results 134 and communicate the search results 134 to the search system front-end 120 during state (G).

Relevance scores can be used to rank the search results 134 in order of relevance with respect to the original query 106 and/or the revised queries 154 using conventional techniques.

The search system front-end 120 can also interact with the snippet generator 190 to generate snippets 192 from the resources referenced by the search results 134. The snippet generator 190 may analyze the content of a resource (e.g., text, metadata, links, etc.) to determine which portions of the resource are particularly relevant to the original query 106, and may return these portions as snippets for the resource.

In some implementations, the snippet generator 190 analyzes the text and/or metadata included in each resource and identifies portions of the text that include the some or all of the query terms. In some implementations, the snippet generator 190 can use various rules (e.g., grammar rules or context-based rules) to identify the portions of the resource that are particularly relevant to the original query 106.

The snippets 192 can be any portion of a resource that is responsive to the original query 106. For example, a snippet can be a word, a phrase, a sentence, a sentence fragment, a title of an audio or video file, a link or URL, and/or title of resource. The snippet generator 190 can associate the snippet to a search result using the resource identifier (e.g., the URI) or other token to identify the search result. The search system 110 can include the snippets 192 as part of the search results 134 that are presented on the search results page 126.

In some implementations, the search system front-end 120 and/or the acronym engine 180 evaluates terms in the original query 122 and/or the search results 134 to determine whether any of the query terms 152 are candidate acronyms 162. In various implementations, each query term is treated as a candidate acronym unless a query term is disqualified from being a candidate acronym based on one or more disqualifying criteria. In some implementations, query terms are disqualified from being candidate acronyms if the terms are numbers, the terms are abbreviations for locations (e.g., “FL” for “Florida”), the terms can represent recursive acronyms (e.g., “gd designs”), the terms are misspelled, the terms are stop words (e.g., “at”), the terms have less than a threshold number of characters (e.g., less than two characters), there is an indication that the terms should be search for as entered, there is an indication that the terms should be considered as a phrase, there is an indication that a term should not be expanded, and queries consisting of only one term (e.g., queries from which context cannot be determined).

Terms that are abbreviations for locations can be determined by performing a lookup operation in a database consisting of specified abbreviations for locations. Terms that represent recursive acronyms can be determined by matching each letter of a candidate acronym to the first letter for the query terms. For example, for a candidate acronym “ad,” the system can identify a recursive acronym by examining the query terms to locate two adjacent terms that begin with the letters “a” and “d.” Thus, query terms, such as, “ad designs,” “ad desktop,” or “ad doormat” can all be identified as recursive acronyms. Terms that are stop words can be determined by performing a lookup operation in a database consisting of specified stop words.

Candidate acronyms can be expanded by matching each letter of each candidate acronym to the first letter for each consecutive or adjacent term in text associated with the search results. For example, for a candidate acronym “eic,” the system can identify candidate expansions by examining the text associated with the search results to locate three adjacent terms that begin with the letters “e,” “i,” and “c,” respectively. Thus, terms, such as, “earned income credit,” “editor in chief,” and “epidermal inclusion cyst,” can all be identified as candidate expansions for “eic.”

In some implementations, consecutive terms in text associated with the search results can be examined to identify candidate expansions. Consecutive terms can be terms that follow each other in text associated with the search results, but are not necessarily adjacent to one another. For example, for a candidate acronym “adc,” the system can identify candidate expansions by examining the text associated with the search results to locate consecutive terms that begin with the letters “a,” “d,” and “c,” respectively. Thus, terms, such as, “association of district counsels,” “analog to digital converter,” and “air area delivery corporation,” can all be identified as candidate expansions for “adc.” In some other implementations, terms that have been joined can be examined to identify candidate expansions. For example, for a candidate acronym “http,” the system can identify candidate expansions by examining text associated with the search results to locate terms that begin with the letters, “h,” “t,” “t,” and “p,” where one or more terms have been joined. Thus, “hypertext transfer protocol” can be identified as a candidate expansion for “http,” even though the terms “hyper” and “text” have been joined. In other examples, a query term can be identified as a candidate acronym even when not every letter of the term is found in consecutive or adjacent terms in text associated with the search results.

In some implementations, terms in the original query are determined to be candidate acronyms based on a match between the query terms and acronyms included in an acronym database. In such implementations, terms in the original query are determined to be candidate acronyms if those terms appear in a database consisting of stored acronyms. In some other implementations, the search system front-end 120 and/or the acronym engine 180 determines candidate expansions for identified candidate acronyms by accessing a database including mappings between candidate acronyms and candidate expansions, and by supplying the synonym engine 160 with candidate expansions.

In some implementations, if candidate acronyms are identified, the original query 122 and the search results 134 are communicated to the acronym engine 180, for use in identifying candidate expansions of one or more candidate acronyms 162 contained in the original query 106, during state (H). If candidate acronyms 162 are identified, the search system front-end may delay generating the search results page 126 until additional search results are obtained using candidate expansions of the candidate acronyms 162. Alternatively, a search results page that identifies the search results 134 may be obtained and communicated to the client device 102 for presentation.

The acronym engine 180 receives, from the synonym engine 160, the candidate acronyms 162 that were identified for one or more original query terms 152 to the acronym engine 180. The acronym engine 180 evaluates the candidate acronyms 162 and the search results 134 to identify candidate expansions for the candidate acronyms 162.

In some implementations, the identified candidate expansion for a candidate acronym used in a particular query context is stored in a database. According to such implementations, a candidate expansion can be identified for a candidate acronym used in a particular query context by performing a lookup operation in the database.

The acronym engine 180 generates one or more revised queries 158 that include the identified candidate expansions and communicates the revised queries 158 to the search system front-end 120 during state (J). During state (L), the revised queries 158 are communicated by the search system front-end 120 to the search engine 130. The search engine 130 generates search results 138 that are responsive to the revised queries 158 that include the candidate expansions, during state (M).

The search system front-end 120 generates a search results page 126 that identifies the search results 138. The search results page 126 can include, for example, titles and snippets associated with each resource referenced by the search results 138. Query terms and synonyms of query terms that appear in the titles and snippets can be formatted in a particular way, for example, in bold font. The search system front-end 120 transmits code (e.g., HyperText Markup Language code or eXtensible Markup Language code) for the search results page 126 to the client device 102 over the network 104 at state (R), to allow the client device 102 to display the search results page 126.

The client device 102 invokes the code (e.g., using a layout engine) and, as a result, displays the search results page 126 on a display. The query terms 152 of the original query 106 are displayed in a query box (or “search box”), located for example, on the top of the search results page 126, and the search results 138 are displayed in a search results block, for example, on the left-hand side of the search results page 126.

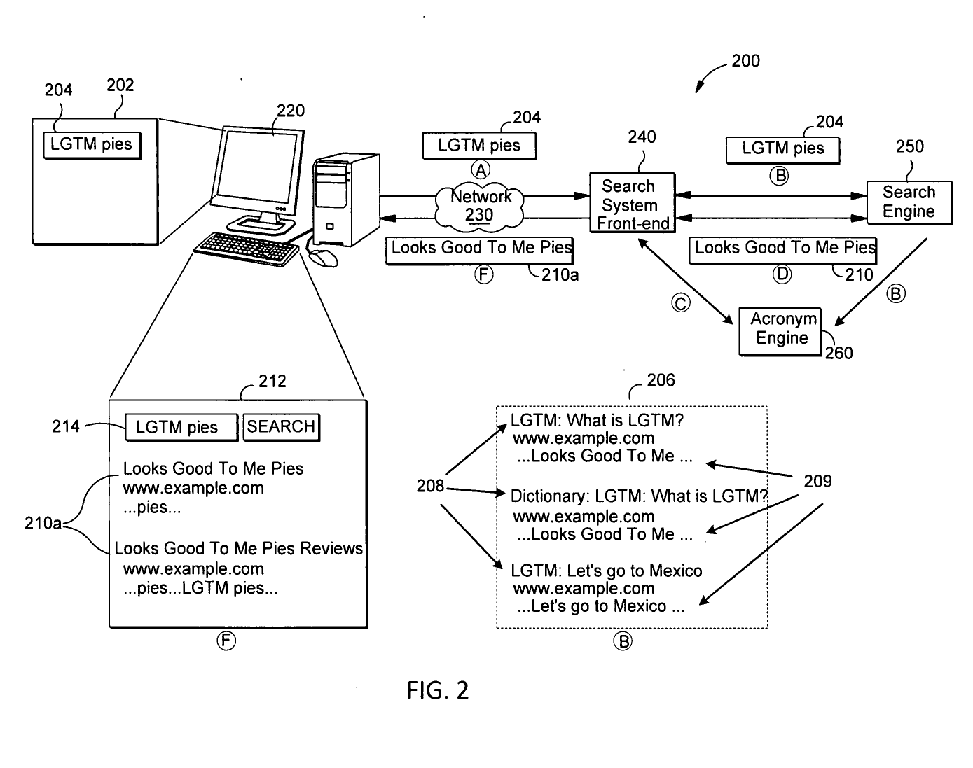

FIG. 2 is a diagram of an example search system 200 in which acronym expansions are used to revise search queries. The system 200 includes a client device 220, a search system front-end 240, a search engine 250, and an acronym engine 260.

A user operating the client device 220 enters query terms 204 (“LGTM pies”) through a search engine home page 202. In FIG. 2, the user is seeking information regarding a business named “Looks Good To Me Pies,” but, instead of the entering the terms “Looks Good To Me,” enters the acronym “LGTM.” The client device 220 communicates the query terms 204 over a network 230 to the search system front-end 240 during state (A).

The search system front-end 240 communicates the query terms 204 to the search engine 250 and, in response, the search engine 250 provides search results 206 responsive to the query terms 204 to the search system front-end 240 and the acronym engine 260 during state (B). The search results 206 may or may not be sent to the client device 220.

In some implementations, the search system front-end 240 determines that search results 206 that are identified in response to the query terms 204 do not satisfy a specified threshold, e.g., a specified relevance threshold or a specified quality threshold and, consequently, triggers an acronym expansion process for one or more terms in the query terms 204 that have been identified as candidate acronyms. A relevance threshold can be used to evaluate the relevance scores for search results 206, which can reflect the relevancy of the search results 206 to the query terms 204. A quality threshold can be used to evaluate the quality scores for each results 206, which can reflect the quality of the search results 206 independent of the query terms 204. In this example, the search system front-end 240 has identified “LGTM” to be a candidate acronym for expansion.

In some other implementations, the acronym expansion process is triggered for one or more terms in the search query that have been entered in all capital letters (e.g., for query terms “EIC skin,” the capital letters of the term “EIC” triggers an acronym expansion process). In some alternative implementations, the acronym expansion process is triggered when the number of characters in the query terms exceed a specified threshold (e.g., given a character threshold of 8 characters, a query for “eic skin” triggers an acronym expansion whereas a query for “eic epidermal inclusion cyst skin” does not).

The search system front-end 240 communicates the identified candidate acronym (“LGTM”) to the acronym engine 260 and, in response, the acronym engine 260 provides a candidate expansion during state (C). In particular, the acronym engine 260 evaluates the search results 206 responsive to the query terms 204 for identifying candidate expansions for the identified candidate acronym (“LGTM”) that were received during state (B).

According to some implementations, the acronym engine 260 examines titles 208 and snippets 209 of documents returned in the search results 206 responsive to the query terms 204 to identify candidate expansions. The system can identify candidate expansions by matching each letter of each candidate acronym to the first letter for each consecutive or adjacent term in the search results. For example, for a identified candidate acronym “LGTM,” the system can identify candidate expansions by examining the search results to locate four consecutive or adjacent terms that begin with the letters “L,” “G,” “T,” and “M,” respectively. Thus, terms, such as, “looks good to me” and “let's go to Mexico,” can all be identified as candidate expansions for “LGTM.”

A candidate expansion is selected. In some implementations, the candidate expansion that occurs the most frequently in the titles 208 and snippets 209 is selected. In the example search results 206, the titles 208 include references to the candidate expansions “Looks Good To Me” and “Let's Go To Mexico.” Further, the snippets 209 include two references to “Looks Good To Me” and one reference to “Let's Go To Mexico.” Based on the frequency of occurrences of the candidate expansions in the example search results 209, the acronym engine 180 selects “Looks Good To Me” as the expansion for the identified candidate acronym “LGTM.”

The search system front-end 240 revises the query terms 204 to include the candidate expansion “Looks Good To Me” as a substitute for the term “LGTM,” and communicates the revised query terms 210 to the search engine 250 for processing. In response, the search engine communicates the subsequently obtained search results 210a responsive to the revised query terms 210 during state (D). According to this implementation, the search system front-end 240 revises the query terms 204 by replacing the identified acronym “LGTM” with the identified expansion “Looks Good To Me,” thereby resulting in a revised query terms 210 for “Looks Good To Me pies.”

The search system front-end 240 communicates the subsequently obtained search results 210 responsive to the revised query terms 210 to the client device 220 over the network 230 during state (F). The client device 220 presents the subsequently obtained search results 210a to the user on a user interface 212. In particular, the user interface 212 includes a query box 214 and search results 210a responsive to the revised query 210. According to this implementation, the query box 214 displays the search query 204 that was entered by the user during state (A). In particular, the displayed search results 210a are responsive to the revised query 210.

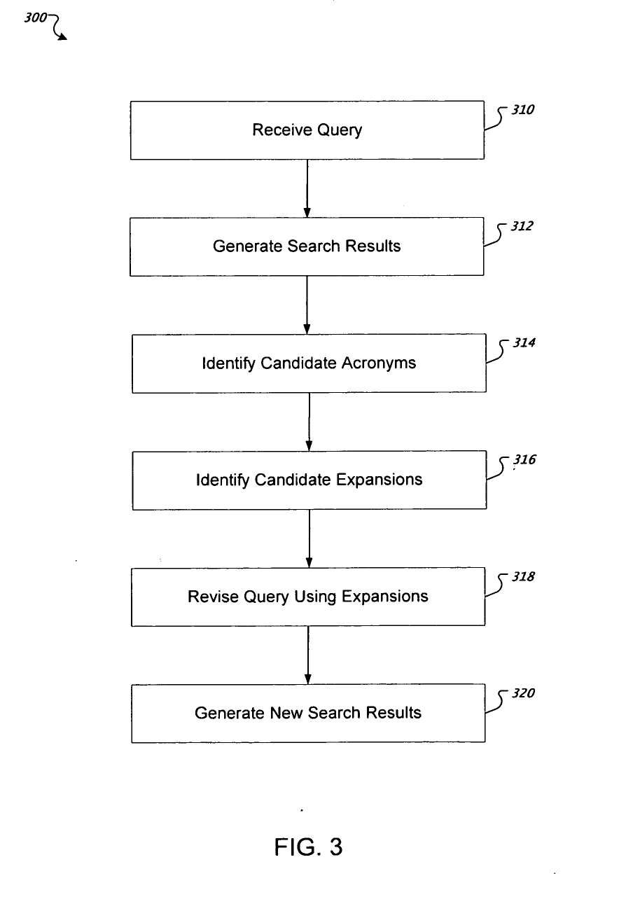

FIG. 3 is a flowchart of an example process for obtaining search results. The process 300 can be performed by a computer system including one or more computers, such as, for example, the search system 110, as shown in FIG. 1.

The system receives a search query from a client device (310). A search query can be received from a client device communicating over a network, where the client device interacts with the system using an interface, such as a network interface. A search query can contain one or more terms and the system can identify synonyms for each term in the search query. The system can also identify acronyms contained in the search query for possible expansion. The identified synonyms and acronyms can be used for revising a search query. In some implementations, the system can identify two or more terms as an expansion of an acronym. For example, for query terms “epidermal inclusion cyst skin,” the system can identify “epidermal inclusion cyst” as an expansion of an acronym “EIC.”

The system obtains search results for the original query (312). For example, a user intending to search for results responsive to a query for “epidermal inclusion cyst skin” may use an acronym for “epidermal inclusion cyst” and enter a query “eic skin.” According to this example, the system retrieves search results responsive to the terms in the entered query: “eic” and “skin.” In various implementations, the system evaluates the quality of the retrieved search results to determine whether to generate subsequent search results using expansions of candidate acronyms contained in the original query. In such implementations, the system can evaluate the quality of the retrieved search results using relevancy scores assigned to documents returned with the search results or relevancy scores assigned to the search results as a set. In some other implementations, subsequent search results are obtained using expansions of candidate acronyms if the retrieved search results include an expansion of a candidate acronym.

In some implementations, the system obtains subsequent search results using expansions of candidate acronyms when relevancy scores for the search results satisfy a specified threshold score. For example, the system can obtain subsequent search results using expansions of candidate acronyms if a relevancy score for the collection of documents returned in the search results are below a specified threshold. In some other implementations, the system obtains subsequent search results using expansions of candidate acronyms in response to user interaction (e.g., when a user clicks a control or selects an option in a drop-down menu). According to such implementations, search results responsive to the original query are not presented to a client device in a case where subsequent search results are to be obtained.

The system identifies one or more query terms as candidate acronyms (314). In some implementations, the system performs a lookup operation using an acronym database, where the lookup operation indicates whether a query term is a candidate acronym. For example, for query terms “eic skin,” the system can perform a lookup operation for “eic” using the acronym database. In response, the acronym database may identify “eic” as a candidate acronym since “eic” can refer to various candidate expansions, such as, “earned income credit,” “editor in chief,” or “epidermal inclusion cyst.” Similarly, the system can perform a lookup operation for “skin,” where the acronym database may determine that “skin” has no known candidate expansions, and therefore has no candidate acronyms. In some other implementations, the system treats each query term as a candidate acronym unless a query term is disqualified from being a candidate acronym based on one or more disqualifying criteria.

The identification process can be tailored to prevent identification of certain terms as candidate acronyms based on one or more disqualifying criteria. In various implementations, the system does not interpret the following as candidate acronyms: terms that are numbers, terms that are abbreviations for locations (e.g., “FL” for “Florida”), terms that can represent recursive acronyms (e.g., “gd designs”), misspelled words, stop words (e.g., “at”), terms having less than a threshold number of characters (e.g., less than two characters), terms placed in quotes, terms with a special designation (e.g., terms with a “+” attached), and queries consisting of only one term (e.g., queries from which context cannot be determined).

The system identifies candidate expansions for the identified candidate acronyms using the search results for the original query (316). In some implementations, the system identifies candidate expansions by searching the content of titles for documents returned with the search results. In some other implementations, the system identifies candidate expansions by searching the content of snippets for documents returned with the search results.

The system can identify candidate expansions by matching each letter of each candidate acronym to the first letter for each consecutive or adjacent term in the search results. For example, for a identified candidate acronym “eic,” the system can identify candidate expansions by examining the search results to locate three consecutive or adjacent terms that begin with the letters “e,” “i,” and “c,” respectively. Thus, terms, such as, “earned income credit,” “editor in chief,” and “epidermal inclusion cyst,” can all be identified as candidate expansions for “eic.”

In some implementations, the selection of candidate expansions for a candidate acronym is further refined based on the number of times a candidate expansion occurs within the search results. For example, a candidate expansion occurring in at least two instances within the search results can identified as an expansion for the candidate acronym (e.g., “earned income credit” can be a candidate expansion for “eic” if it is referenced two or more times in the search results).

In some implementations, selection of a candidate expansion is determined based on the number of occurrences of that candidate expansion in a particular document returned With the search results (e.g., “earned income credit” can be identified as a candidate expansion if it occurs at least twice in one of the documents returned with the search results). In some other implementations, selection of a candidate expansion is determined based on the number of occurrences of that candidate expansion in a subset of the documents returned with the search results (e.g., “earned income credit” can be identified as a candidate expansion if it occurs at least twice in three of the top ten documents returned with the search results).

In yet some other implementations, selection of a candidate expansion is determined based on the number of occurrences of that candidate expansion in all of the documents returned with the search results (e.g., “earned income credit” can be identified as a candidate expansion if it occurs at least twice in all of the documents returned with the search results). In some alternative implementations, selection of a candidate expansion is determined based on the candidate expansion occurring in a specified number of search results (e.g., the candidate expansion is referenced in three out of the top ten search results).

According to such implementations, a candidate expansion meeting the specified criteria is identified as the expansion for the candidate acronym. In situations where multiple candidate expansions are identified for a candidate acronym (e.g., “earned income credit” and “editor in chief” are both present in the search results), the system can identify the candidate expansion appearing the most frequently in the search results as the expansion for the candidate acronym. For example, for an acronym “eic,” the search results may have three occurrences for “epidermal inclusion cyst” and only two occurrences for “editor in chief.” In this case, the system can use “epidermal inclusion cyst” as the expansion for “eic.”

In some implementations, candidate expansions that were identified but not selected are presented to a user as alternate expansions for revising search results. For example, for query terms “doe budget,” the system can select “department of energy” as a candidate expansion for “doe,” and present “department of engineering” as an alternate expansion, which can be selected by a user to revise the search results. In some other implementations, candidate expansions that were identified but not selected are used to revise search results that were obtained for a selected candidate expansion. In such implementations, revised search results are obtained using a candidate expansion that was identified but not selected when a user advances to a second search results page without selecting any search results appearing on a first search results page.

The system revises the original query using expansions for the identified candidate acronyms (318). In various implementations, the system generates one or more revised queries by adding candidate expansion for one or more candidate acronyms to the original query. For example, for query terms “eic skin,” where a candidate expansion for “eic” is “epidermal inclusion cyst,” the system can generate the following revised query: “eic epidermal inclusion cyst skin.”

In some other implementations, the system generates one or more revised queries by substituting candidate expansions for one or more candidate acronyms to the original query. For example, for query terms “eic skin,” where a candidate expansion for “eic” is “epidermal inclusion cyst,” the system can generate the following revised query: “epidermal inclusion cyst skin.”

The system obtains search results identified as being responsive to the revised query (320). The system can communicate the search results to the client device, where the results are presented to the user. In some implementations, the display of search results for the revised query is seamless to the user, such that the search results for the revised query are presented without displaying the terms of revised query in the query box (or “search box) on the user interface (i.e., a user is presented search results for the revised query, but still sees terms of the original query displayed in the query box).

In some other implementations, search results from the original query can be blended with search results for the revised query. For example, the system can present a user some documents returned with search results for the original query and some documents returned with search results for the revised query. In some implementations, selection of documents to be blended is based on document relevance scores.

In some other implementations, search results identified as being responsive to the original query are presented along with options for selecting alternate queries that were generated by substituting candidate expansions for one or more candidate acronyms in the original query. For example, search results responsive to query terms “doe budget” can be presented along with options for obtaining revised search queries responsive to query terms “department of energy budget” or “department of engineering budget.” In yet some other implementations, search results identified as being responsive to the original query are presented with identified candidate expansions highlighted in the text associated with the search results.

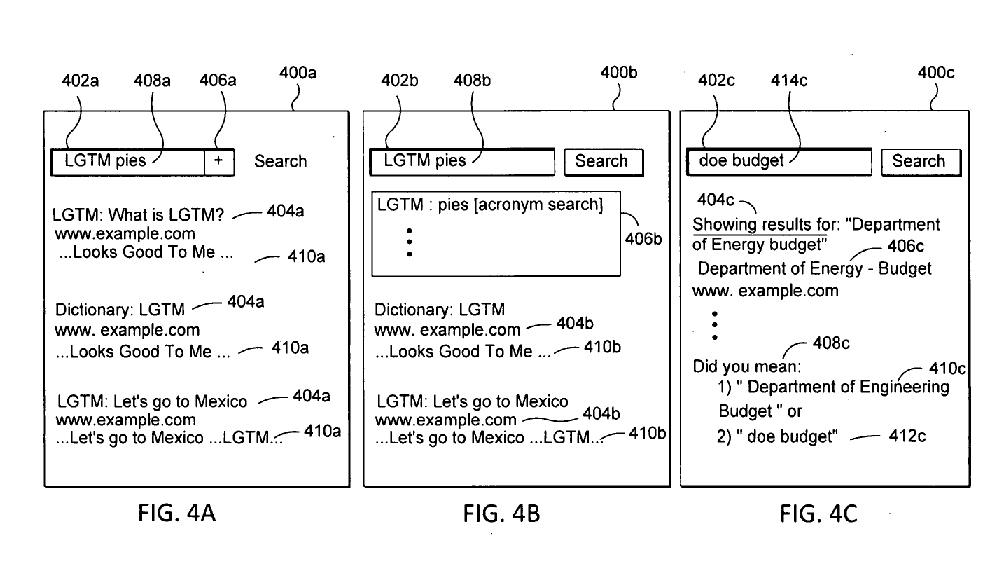

FIG. 4A is an example user interface 400a. The user interface 400a includes a query box 402a, search results 404a, an acronym expansion trigger control 406a, an query terms 408a (“LGTM pies”), and snippets 410a. Users can initiate searches for queries by entering queries into the query box 402a. As shown, the query box 402a is populated with query terms 408a (“LGTM pies”), and the search results 404a displayed are responsive to the original query 408a.

The acronym expansion trigger control 406a can be activated by user interaction. According to this example, a user can activate the trigger control 406a to trigger a subsequent search using expansions of acronyms that were included in the query terms 408a (e.g., “LGTM”). In this example, user activation of the trigger control 406a can be used to instruct whether an acronym expansion is performed for the query terms 408a. In particular, instructing whether an acronym expansion is performed can be accomplished by including an additional signal in the search query to trigger acronym expansion of the query terms 408a. The acronyms included in the query terms 408a can be expanded by analyzing titles of search results 404a or snippets 410a for documents returned with search results 404a. For example, as shown in the snippets 410a for search results 404a, the candidate expansions identified for the acronym “LGTM” may be “Looks Good To Me” or “Let's Go To Mexico.”

FIG. 4B is an example user interface 400b. The user interface 400b includes a query box 402b, search results 404b, a drop-down menu option 406b for triggering acronym expansion, query terms 408b (“LGTM pies”), and snippets 410b. Users can initiate searches for queries by entering queries into the query box 402b. As shown, the query box 402b is populated with query terms 408b (“LGTM pies”), and the search results 404b displayed are responsive to the query terms 408b. The drop-down menu option 406b for triggering acronym expansion (“LGTM pies [acronym search]”) can be selected by user interaction.

According to the example shown in FIG. 4B, a user can select the drop-down menu option 406b for triggering acronym expansion to trigger a subsequent search using expansions of acronyms that were included in the query terms 408b (“LGTM”). The acronyms included in the original query 408b can be expanded by analyzing titles of search results 404b or snippets 410b for documents returned with search results 404b. For example, as shown in the snippets 410b, the candidate expansions identified for the acronym “LGTM” may be “Looks Good To Me” or “Let's Go To Mexico.”

FIG. 4C is an example user interface 400c. The user interface 400c includes a query box 402c. As shown, the query box 402c is populated with query terms 414c (“doe budget”). In this example, the system has already expanded identified acronyms in the query terms 402c (“doe”) without any user interaction to generate expanded query terms 404c (“department of energy budget”). The displayed search results 406c are responsive to the expanded query terms 404c (“department of energy budget”). As depicted in the user interface 400c, a user is presented with options 408c to obtain subsequent search results. In particular, the user can choose to obtain subsequent search results responsive to an alternative expanded query terms 410c for a different expansion (“department of engineering”) of the identified acronym (“doe”). The user is also presented with an option 412c to obtain search results using the query terms 414c.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by'sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area. network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a search query that includes a query term from a client device;
obtaining first set of search results for the search query;
determining that the query term is classified as a candidate acronym;
based on determining that the query term is classified as a candidate acronym, identifying a candidate acronym expansion of the query term from text associated with the first set of search results, comprising:
obtaining, for each of multiple search results of the first set, a set of terms from the text associated with the search result,
identifying, for each of the multiple search results of the first set, a first character from each term of the set of terms from the text associated with the search result,
generating, for each of the multiple search results of the first set, a sequence of characters that comprises the first character from each term of the set of terms from the text associated with the search result,
determining, for each of the multiple search results of the first set, that the query term matches the sequence of characters that comprises a first character from each term of a set of terms from the text associated with the search result, and
determining that a quantity of the multiple search results of the first set in which the query term matches the sequence of characters, satisfies a threshold;
in response to determining that a quantity of the multiple search results of the first set in which the query term matches the sequence of characters, satisfies a threshold, revising the search query to include the candidate acronym expansion of the query term; and
obtaining second set of search results for the revised search query.

2. (canceled)

3. The method of claim 1, wherein based on determining that the query term is classified as a candidate acronym, identifying the candidate acronym expansion of the query term from text associated with the first set of search results comprises:
receiving a user selection indicating that the query term is a candidate acronym.

4. The method of claim 1, wherein the text associated with the first set of search results is one or more snippets of the first set of search results.

5. The method of claim 1, wherein the text associated with the first set of search results is one or more titles of the first set of search results.

6-9. (canceled)

10. The method of claim 1, wherein based on determining that the query term is classified as a candidate acronym, identifying a candidate acronym expansion of the query term from text associated with the first set of search results comprises:
determining a quantity of search results in the first set of search results that reference a document in which the candidate acronym expansion is included;
determining that the quantity of search results in the first set of search results that reference a document in which the candidate acronym expansion is included satisfies a threshold; and
in response to determining that the quantity of search results in the first set of search results that reference a document in which the candidate acronym expansion is included exceeds a specified threshold, identifying the candidate acronym expansion as the candidate acronym expansion of the query term.

11. The method of claim 1, wherein revising comprises adding the candidate acronym expansion to the search query.

12. The method of claim 1, wherein revising the search query comprises substituting the candidate acronym expansion for the query term in the search query.

13. The method of claim 1, wherein the second set of search results include results from the first set of search results and additional results.

14. The method of claim 13, wherein documents returned with the first and second set of search results are included in the obtained second set of search results.

15. The method of claim 1, further comprising providing the obtained second set of search results for display to a user.

16. The method of claim 1, further comprising:
determining that the query term satisfies one or more exclusionary rules; and
in response to the determination, identifying a candidate acronym expansion of the query term from text associated with the first set of search results.

17. The method of claim 1, wherein the first set of search results are not provided for display to a user.

18. A system, comprising:
one or more computers programmed to perform operations comprising:
receiving a search query that includes a query term from a client device;
obtaining first set of search results for the search query;
determining that the query term is classified as a candidate acronym;
based on determining that the query term is classified as a candidate acronym, identifying a candidate acronym expansion of the query term from text associated with the first set of search results, comprising;
obtaining, for each of multiple search results of the first set, a set of terms from the text associated with the search result,
identifying, for each of the multiple search results of the first set, a first character from each term of the set of terms from the text associated with the search result,
generating, for each of the multiple search results of the first set, a sequence of characters that comprises the first character from each term of the set of terms from the text associated with the search result,
determining, for each of the multiple search results of the first set, that the query term matches the sequence of characters that comprises a first character from each term of a set of terms from the text associated with the search result, and
determining that a quantity of the multiple search results of the first set in which the query term matches the sequence of characters, satisfies a threshold;
in response to determining that a quantity of the multiple search results of the first set in which the query term matches the sequence of characters, satisfies a threshold, revising the search query to include the candidate acronym expansion of the query term; and
obtaining second set of search results for the revised search query.

19. (canceled)

20. The system of claim 18, wherein based on determining that the query term is classified as a candidate acronym, identifying the candidate acronym expansion of the query term from text associated with the first set of search results comprises:
receiving a user selection indicating that the query term is a candidate acronym.

21. The system of claim 18, wherein the text associated with the first set of search results is one or more snippets of the first set of search results.

22. The system of claim 18, wherein the text associated with the first set of search results is one or more titles of the first set of search results.

23-26. (canceled)

27. The system of claim 18, wherein based on determining that the query term is classified as a candidate acronym, identifying a candidate acronym expansion of the query term from text associated with the first set of search results comprises:
determining a quantity of search results in the first set of search results that reference a document in which the candidate acronym expansion is included;
determining that the quantity of search results in the first set of search results that reference a document in which the candidate acronym expansion is included satisfies a threshold; and
in response to determining that the quantity of search results in the first set of search results that reference a document in which the candidate acronym expansion is included exceeds a specified threshold, identifying the candidate acronym expansion as the candidate acronym expansion of the query term.

28. The system of claim 18, wherein revising comprises adding the candidate acronym expansion to the search query.

29. The system of claim 18, wherein revising the search query comprises substituting the candidate acronym expansion for the query term in the search query.

30. The system of claim 18, wherein the second set of search results include results from the first set of search results and additional results.

31. The system of claim 30, wherein documents returned with the first and second set of search results are included in the obtained second set of search results.

32. The system of claim 18, further comprising providing the obtained second set of search results for display to a user.

33. The system of claim 18, further comprising:
determining that the query term satisfies one or more exclusionary rules; and
in response to the determination, identifying a candidate acronym expansion of the query term from text associated with the first set of search results.

34. The system of claim 18, wherein the first set of search results are not provided for display to a user.

35. A non-transitory computer storage medium encoded with instructions that when executed by one or more computers cause the one or more computers to perform operations comprising:
receiving a search query that includes a query term from a client device;
obtaining first set of search results for the search query;
determining that the query term is classified as a candidate acronym;
based on determining that the query term is classified as a candidate acronym, identifying a candidate acronym expansion of the query term from text associated with the first set of search results, comprising;
obtaining, for each of multiple search results of the first set, a set of terms from the text associated with the search result,
identifying, for each of the multiple search results of the first set, a first character from each term of the set of terms from the text associated with the search result,
generating, for each of the multiple search results of the first set, a sequence of characters that comprises the first character from each term of the set of terms from the text associated with the search result,
determining, for each of the multiple search results of the first set, that the query term matches the sequence of characters that comprises a first character from each term of a set of terms from the text associated with the search result, and
determining that a quantity of the multiple search results of the first set in which the query term matches the sequence of characters, satisfies a threshold;
in response to determining that a quantity of the multiple search results of the first set in which the query term matches the sequence of characters, satisfies a threshold, revising the search query to include the candidate acronym expansion of the query term; and
obtaining second set of search results for the revised search query.

36. (canceled)

37. The non-transitory computer storage medium of claim 35, wherein based on determining that the query term is classified as a candidate acronym, identifying the candidate acronym expansion of the query term from text associated with the first set of search results comprises:
receiving a user selection indicating that the query term is a candidate acronym.

38. The non-transitory computer storage medium of claim 35, wherein the text associated with the first set of search results is one or more snippets of the first set of search results.

39. The non-transitory computer storage medium of claim 35, wherein the text associated with the first set of search results is one or more titles of the first set of search results.

40-43. (canceled)

44. The non-transitory computer storage medium of claim 35, wherein based on determining that the query term is classified as a candidate acronym, identifying a candidate acronym expansion of the query term from text associated with the first set of search results comprises:
determining a quantity of search results in the first set of search results that reference a document in which the candidate acronym expansion is included;
determining that the quantity of search results in the first set of search results that reference a document in which the candidate acronym expansion is included satisfies a threshold; and
in response to determining that the quantity of search results in the first set of search results that reference a document in which the candidate acronym expansion is included exceeds a specified threshold, identifying the candidate acronym expansion as the candidate acronym expansion of the query term.

45. The non-transitory computer storage medium of claim 35, wherein revising comprises adding the candidate acronym expansion to the search query.

46. The non-transitory computer storage medium of claim 35, wherein revising the search query comprises substituting the candidate acronym expansion for the query term in the search query.

47. The non-transitory computer storage medium of claim 35, wherein the second set of search results include results from the first set of search results and additional results.

48. The non-transitory computer storage medium of claim 47, wherein documents returned with the first and second set of search results are included in the obtained second set of search results.

49. The non-transitory computer storage medium of claim 35, further comprising providing the obtained second set of search results for display to a user.

50. The non-transitory computer storage medium of claim 35, further comprising:
determining that the query term satisfies one or more exclusionary rules; and
in response to the determination, identifying a candidate acronym expansion of the query term from text associated with the first set of search results.

51. The non-transitory computer storage medium of claim 35, wherein the first set of search results are not provided for display to a user.

52. The method of claim 1, further comprising:
determining whether to obtain second set of search results based on a quality of the first set of search results;
based on determining to obtain second set of search results, identifying a candidate acronym expansion of the query term from text associated with the first set of search results;
revising the search query to include the candidate acronym expansion of the query term; and
obtaining second set of search results for the revised search query.

53. The method of claim 1, wherein identifying a candidate acronym expansion of the query term from text associated with the first set of search results comprises:
identifying, from text associated with the first set of search results, a set of terms, wherein terms in the set of terms appear in the text as being consecutive or adjacent to other terms in the set of terms, wherein each character in the query term sequentially matches a first character of a term in the set of terms.

54. The system of claim 18, wherein the operations further comprise:
determining whether to obtain second set of search results based on a quality of the first set of search results;
based on determining to obtain second set of search results, identifying a candidate acronym expansion of the query term from text associated with the first set of search results;
revising the search query to include the candidate acronym expansion of the query term; and
obtaining second set of search results for the revised search query.

55. The system of claim 18, wherein identifying a candidate acronym expansion of the query term from text associated with the first set of search results comprises:
identifying, from text associated with the first set of search results, a set of terms, wherein terms in the set of terms appear in the text as being consecutive or adjacent to other terms in the set of terms, wherein each character in the query term sequentially matches a first character of a term in the set of terms.

56. The non-transitory computer storage medium of claim 35, wherein the operations further comprise:
determining whether to obtain second set of search results based on a quality of the first set of search results;
based on determining to obtain second set of search results, identifying a candidate acronym expansion of the query term from text associated with the first set of search results;
revising the search query to include the candidate acronym expansion of the query term; and
obtaining second set of search results for the revised search query.

57. The non-transitory computer storage medium of claim 35, wherein identifying a candidate acronym expansion of the query term from text associated with the first set of search results comprises:
identifying, from text associated with the first set of search results, a set of terms, wherein terms in the set of terms appear in the text as being consecutive or adjacent to other terms in the set of terms, wherein each character in the query term sequentially matches a first character of a term in the set of terms.
